(19) United States
(12) Patent Application Publication
(10) Pub. No.: US 2024/0027570 A1
(43) Pub. Date: Jan. 25, 2024

(54) ULTRA-WIDEBAND CHANNEL USAGE COORDINATION

(71) Applicant: APPLE INC., Cupertino, CA (US)

(72) Inventors: Lochan Verma, Cupertino, CA (US); Robert Golshan, Cupertino, CA (US); Robert W. Brumley, San Jose, CA (US); Yong Liu, Cupertino, CA (US)

(21) Appl. No.: 18/347,743

(22) Filed: Jul. 6, 2023

Related U.S. Application Data
(60) Provisional application No. 63/369,032, filed on Jul. 21, 2022.

(51) Int. Cl. G01S 5/02; G01S 17/50; H04W 64/00

(52) U.S. Cl. CPC G01S 5/0284; G01S 17/50; H04W 64/003

(57) ABSTRACT

A wireless device may coordinate UWB channel usage with neighboring devices. In some embodiments, an initiator may periodically send an ultra-wideband acquisition packets (UWB-AP). The UWB-AP may comprise information of future UWB channel usage of the initiator. Neighboring UWB devices may receive the UWB-AP and adjust channel usage based on the UWB-AP.

### TECHNICAL FIELD

This application relates generally to wireless communication systems, including coordination of ultra-wideband channel usage with neighboring devices.

### BACKGROUND

Wireless communication technology uses various standards and protocols to transmit data between wireless communication devices. Wireless communication system standards and protocols can include, for example, wireless personal area networks (WPANs), fine ranging (FiRa), IEEE 802.15.4 standard for Low-Rate Wireless Networks, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by IEEE 802.15, wireless signals can be used to communicate between devices. IEEE 802.15 defines standards addressing wireless networking for the emerging Internet of Things (IoT), allowing these devices to communicate and interoperate with one another. The devices may include mobile devices, wearables, autonomous vehicles, etc.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a UWB transmission schedule of a transmitter or initiator for UWB channel usage coordination in accordance with some embodiments.

FIG. 2 illustrates an example OOB-aided UWB transmission schedule of a transmitter or initiator for UWB channel usage coordination in accordance with some embodiments.

FIG. 3 illustrates the format of a UWB-AP in accordance with some embodiments.

FIG. 4 illustrates the format of an NB-AP in accordance with some embodiments.

FIG. 5 illustrates an area size for UWB coordination in accordance with some embodiments.

FIG. 6 illustrates a system for performing signaling between a wireless device and a network device, according to embodiments disclosed herein.

### DETAILED DESCRIPTION

Ultra-wideband (UWB) technology facilitates short-range wireless communication over a wide frequency spectrum. UWB technology provides two important properties, secure and accurate proximity detection and low-latency (high speed) data communication. This combination of properties makes it ideal for many applications. For example, UWB's secure and accurate proximity detection property may be used for digital keys or for device location.

Technical standards, such as IEEE802.15.4ab, define operation of UWB communications. One goal of IEEE802.15.4ab is to enhance low-latency (high speed) data communication over UWB. UWB technology adoption is expected to grow significantly in the coming years. An increase of UWB devices may result in significant interference if the technical standards do not properly address the increased wireless traffic.

Therefore, it is very desirable that UWB transmitters be good neighbors to each other. Coordination of UWB channel usage between the UWB transmitters is one way to improve inter-UWB coexistence. Additionally, two categories of UWB transceivers are possible: standalone-UWB transceivers and out-of-band (OOB)-aided UWB transceivers. OOB-aided UWB transceivers include devices that have both a UWB transceiver and another transceiver, such as Bluetooth low energy (BLE) or a narrowband radio, which can be used to assist the UWB transceiver.

Coordination of UWB channel usage is one method to facilitate better inter-UWB transmitter co-existence. UWB transmitters may be able to coordinate UWB channel usage by discovering each other, and acquiring UWB timing of each other. Some embodiments herein describe UWB channel usage coordination methods that may be used by both standalone-UWB and OOB-aided UWB transceivers. Further, some embodiments, describe UWB channel usage coordination methods that allow a heterogeneous UWB transceiver environment to collaborate with each other for improved coexistence. A heterogeneous UWB transceiver environment is an environment that uses both standalone-UWB and OOB-aided UWB transceivers. In some embodiments, the coordination method signaling is decoupled from UWB transmission schedules.

Various embodiments are described with regard to a UWB transmitters, UWB transceiver, wireless device, user equipment (UE), initiator, controller, or responder. However, reference to a UWB transmitters, UWB transceiver, wireless device, UE, initiator, controller, or responder is merely provided for illustrative purposes. The example embodiments may be utilized with any electronic component that may establish a UWB communication interface and is configured with the hardware, software, and/or firmware to exchange information and data over the UWB communication interface. Therefore, the UE as described herein is used to represent any appropriate electronic component.

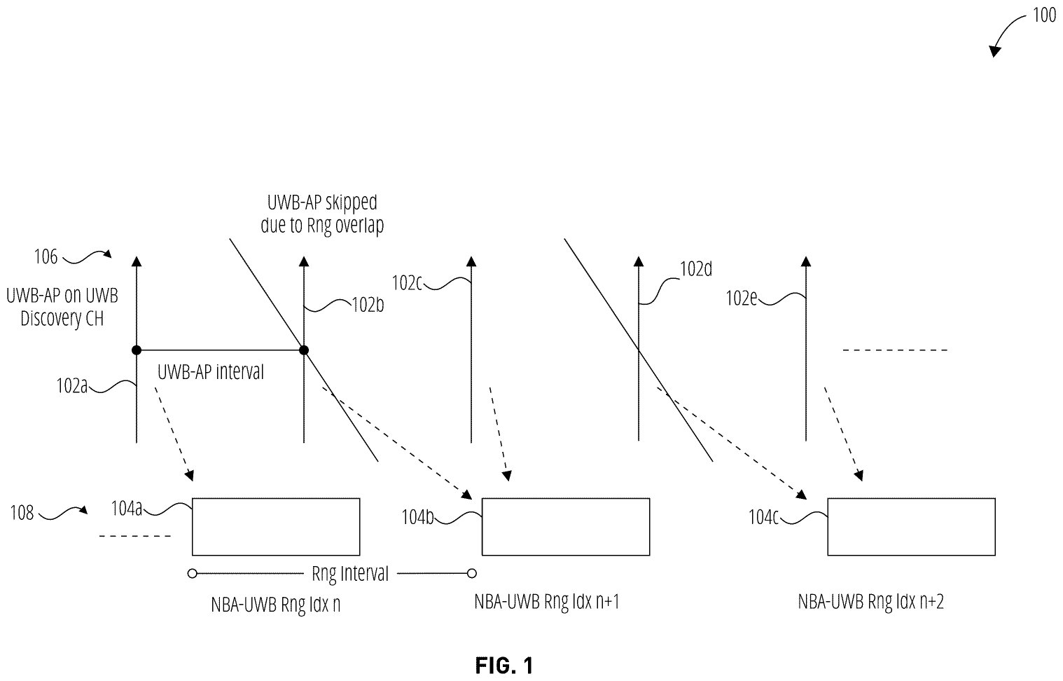

FIG. 1 illustrates an example of a UWB transmission schedule 100 of a transmitter or initiator for UWB channel usage coordination in accordance with some embodiments. As shown, there may be two types of signals sent by a transmitter during the UWB transmission schedule 100. The transmissions from a transmitter may include coordination signaling 106 and UWB activity 108. In the illustrated embodiment, both the coordination signaling 106 and the UWB activity 108 are sent by the transmitter using UWB frequencies.

Coordination signaling 106 may include UWB-acquisition packets (e.g., UWB-AP 102a, UWB-AP 102b, UWB-AP 102c, UWB-AP 102d, UWB-AP 102e) transmitted by an initiator. Both standalone-UWB initiators and OOB-aided UWB initiators or controllers may periodically transmit a UWB-AP on a pre-defined UWB discovery channel. In some embodiments, the discovery channel may be defined in a standard.

In some embodiments, each UWB-AP comprises information useful to determine all future UWB channel usage for a corresponding initiator. For example, the transmitter may encode within each of UWB-AP 102a, UWB-AP 102b, UWB-AP 102c, UWB-AP 102d, and UWB-AP 102e data related to scheduling information of the UWB activity 108. A receiver may receive and decode any one of the UWB-APs and from that one UWB-AP be able to predict future UWB activity 108. It may not be necessary for a receiver to receive more than one UWB-AP to predict all future UWB activity 108 from a transmitter corresponding to the UWB-AP.

UWB activity 108 may include ranging and high speed data communication (e.g., streaming). The transmissions for ranging, streaming, etc. may be referred to generally as a UWB session transmission. If UWB activity 108 overlaps with a UWB-AP, the transmitter may skip sending that occurrence of the UWB-AP. For example, UWB-AP 102b and UWB-AP 102d are skipped because of ranging activity 104a and ranging activity 104b. While the illustrated embodiment only includes ranging, UWB activity 108 may also include high speed data communication such as streaming.

Both standalone-UWB and OOB-aided UWB initiators and responders discover a nearby initiator by receiving UWB-AP. Each UWB device may monitor the discovery channel for UWB-APs of neighboring devices. When the UWB device receives a UWB-AP for a neighboring device, the UWB device may adapt its UWB transmission activity based on the UWB-AP. For example, the UWB device may use a different frequency and/or timing than the neighboring device.

In some embodiments, the UWB-AP interval is implementation choice. That is, each device may be programed with a period between UWB-AP transmissions, and the period between UWB-AP transmissions may not be the same as other devices. For example, some devices may have a UWB-AP interval set to 30 milliseconds, while other devices may have a UWB-AP interval set to 180 milliseconds. The frequency of the UWB-AP transmission may be up to the configuration of that UWB device. This may allow devices that are more power sensitive to implement a larger UWB-AP interval. In some embodiments, a standard may define a maximum or suggested UWB-AP interval.

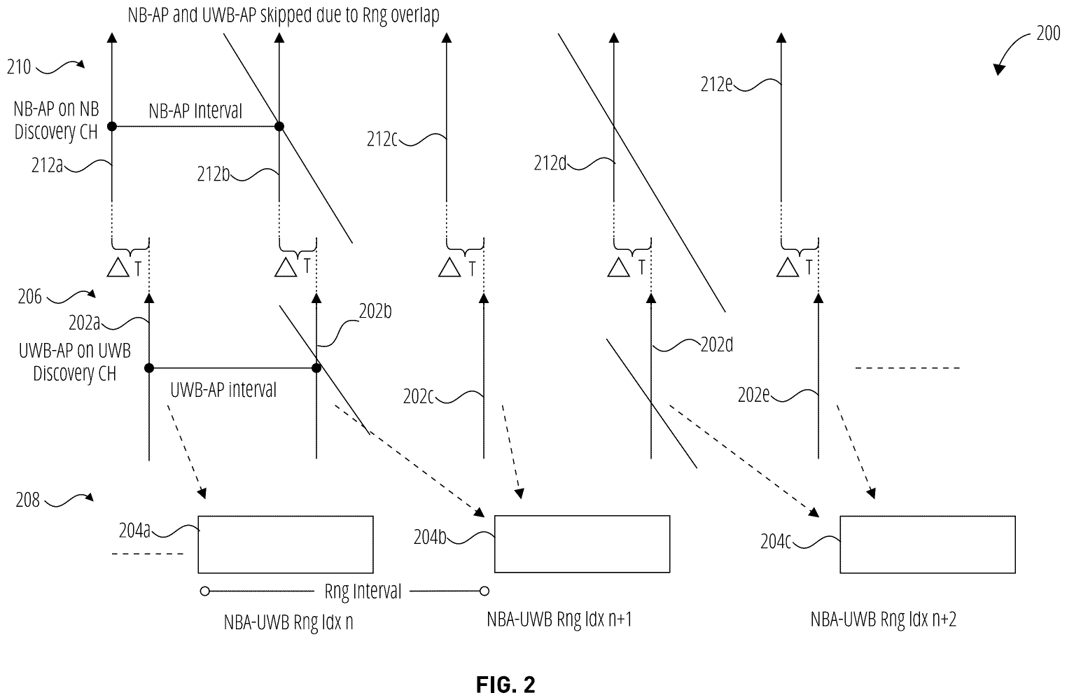

FIG. 2 illustrates an example OOB-aided UWB transmission schedule 200 of a transmitter or initiator for UWB channel usage coordination in accordance with some embodiments. As shown, there may be three types of signals sent by a transmitter during the OOB-aided UWB transmission schedule 200. The transmissions from a transmitter may include OOB coordination signaling 210, UWB coordination signaling 206, and UWB activity 208. In the illustrated embodiment, both the UWB coordination signaling 206 and the UWB activity 208 are sent by the transmitter using UWB frequencies, and the OOB coordination signaling 210 may be sent using narrowband (NB) frequencies.

A UWB receiving scan for UWB-AP may be optimized in OOB-aided UWB transceivers using the OOB coordination signaling 210. The OOB coordination signaling 210 may include OOB-APs (e.g., OOB-AP 212a, OOB-AP 212b, OOB-AP 212c, OOB-AP 212d, and OOB-AP 212e). An OOB-aided UWB initiator may periodically transmit OOB-AP on a pre-defined OOB Discovery channel. In some embodiments, each OOB-AP carries information useful to determine occurrence of the next immediate UWB-AP. An OOB-aided UWB transceiver may use the OOB coordination signaling 210 to reduce the amount of time spent scanning for the UWB-AP thereby reducing power consumption.

The OOB-AP interval (i.e, the time between OOB-APs) may be implementation choice. That is, each device may be programed with a period between OOB-AP transmissions, and the period between OOB-AP transmissions may not be the same as other devices. For example, some devices may have an OOB-AP interval set to 30 milliseconds, while other devices may have an OOB-AP interval set to 180 milliseconds. The frequency of the OOB-AP transmission may be up to the configuration of that device. This may allow devices that are more power sensitive to implement a larger OOB-AP interval. In some embodiments, a standard may define a maximum or suggested OOB-AP interval. In some embodiments, the OOB-AP interval may be set based on the UWB-AP interval.

In some embodiments, the time difference between an OOB-AP and a next UWB-AP (i.e., ΔT) may be included in the OOB-AP. A receiver that obtains an OOB-AP may decode the OOB-AP and determine that the UWB-AP will be transmitted after ΔT. Thus, the receiver may scan the UWB discovery channel for ΔT to obtain a UWB-AP. This may shorten the scan duration of the UWB discovery channel and thereby reduce the power consumption of the receiver.

In some embodiments, the time difference between an OOB-AP and a next UWB-AP (i.e., ΔT) may be predefined. A predefined ΔT may be set via a technical standard. If a predefined ΔT is implemented, a receiver that obtains an OOB-AP may know that the UWB-AP will be transmitted after ΔT. Thus, the receiver may scan the UWB discovery channel for ΔT to obtain a UWB-AP. This may shorten the scan duration of the UWB discovery channel and thereby reduce the power consumption of the receiver.

The OOB coordination signaling 210 may be transmitted using technology outside of UWB. For example, in the illustrated embodiment, NB technology is used by an initiator to transmit a NB-AP on a NB discovery channel. Narrowband assisted UWB is one example of an OOB-aided UWB transceiver. In other embodiments, Bluetooth technology (e.g., BLE) may be used by the initiator to transmit an AP. For example, a device may transmit a periodic BLE advertisement on a BLE discovery channel.

UWB Coordination signaling 206 may include UWB-acquisition packets (e.g., UWB-AP 202a, UWB-AP 202b, UWB-AP 202c, UWB-AP 202d, UWB-AP 202e) transmitted by an initiator. Both standalone-UWB initiators and OOB-aided UWB initiators or controllers may periodically transmit a UWB-AP on a pre-defined UWB discovery channel. In some embodiments, the discovery channel may be defined in a standard.

In some embodiments, each UWB-AP comprises information useful to determine all future UWB channel usage for a corresponding initiator. For example, the transmitter may encode within each of UWB-AP 202a, UWB-AP 202b, UWB-AP 202c, UWB-AP 202d, and UWB-AP 202e data related to scheduling information of the UWB activity 108. A receiver may receive and decode any one of the UWB-APs and from that one UWB-AP be able to predict future UWB activity 208. It may not be necessary for a receiver to receive more than one UWB-AP to predict all future UWB activity 208 from a transmitter corresponding to the UWB-AP.

UWB activity 208 may include ranging and high speed data communication (e.g., streaming). If UWB activity 208 overlaps with a UWB-AP, the transmitter may skip sending that occurrence of the UWB-AP and the associated OOB-AP. For example, OOB-AP 212b, OOB-AP 212d, UWB-AP 202b, and UWB-AP 202d are skipped because of ranging activity 104a and ranging activity 104b. While the illustrated embodiment only includes ranging, UWB activity 108 may also include high speed data communication such as streaming.

Both standalone-UWB and OOB-aided UWB initiators and responders discover a nearby initiator by receiving UWB-AP. Each UWB device may monitor the discovery channel for UWB-APs of neighboring devices. While the OOB-aided UWB devices may be added using OOB coordination signaling 210, the standalone-UWB devices may still scan the UWB-AP discovery channel for UWB-AP. When the UWB device receives a UWB-AP for a neighboring device, the UWB device may adapt its UWB transmission activity based on the UWB-AP. For example, the UWB device may use a different frequency, channel, and/or timing than the neighboring device.

In some embodiments, the UWB-AP interval is implementation choice. That is, each device may be programed with a period between UWB-AP transmissions, and the period between UWB-AP transmissions may not be the same as other devices. For example, some devices may have a UWB-AP interval set to 30 milliseconds, while other devices may have a UWB-AP interval set to 180 milliseconds. The frequency of the UWB-AP transmission may be up to the configuration of that UWB device. This may allow devices that are more power sensitive to implement a larger UWB-AP interval. In some embodiments, a standard may define a maximum or suggested UWB-AP interval.

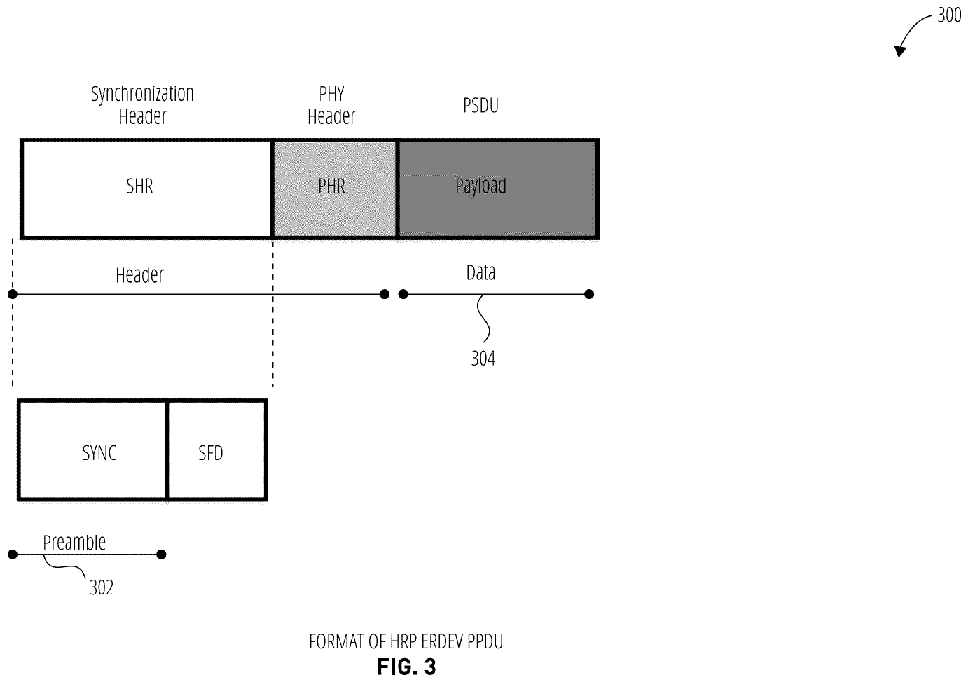

FIG. 3 illustrates the format of a UWB-AP 300 (e.g., UWB-AP 102a from FIG. 1, or UWB-AP 202a from FIG. 2) in accordance with some embodiments. The UWB-AP 300 may carry information that may be used by a device to predict future occupation of a UWB channel. The packet type of the UWB-AP 300 may be a base pulse repetition frequency (BPRF) Data Packet. For example, the BPRF data packet may be scrambled timestamp sequence (STS) Packet Config 0, High Rate Pulse (HRP) enhanced ranging device (ERDEV) physical layer protocol data unit (PPDU).

Properties of the UWB-AP 300 may be predefined to make the discovery and decoding of the UWB-AP 300 possible. The preamble 302 may be predefined. For example, the preamble 302 may be implemented in a specification. Receivers in the vicinity of an initiator may use the preamble 302 to decode the UWB-AP 300. Additionally, where the UWB-AP 300 is transmitted may also be predefined. For example, a designated UWB discovery channel may be predefined. For instance, the UWB discovery channel may be channel 5, channel 9, or channel 11.

The UWB-AP 300 may include a payload comprising information (e.g., data 304) that provides information about one or more UWB sessions. For instance, the data 304 may include a relative offset from the UWB-AP 300 to the next UWB activity (e.g., ranging round or data streaming event). A device that receives the UWB-AP 300 may use the relative offset to calculate a time of the next UWB event for the initiator based on the time that the UWB-AP 300 was received. The data 304 may include a length of the next UWB event. For example, for a ranging round, the data 304 may include a ranging round length. The data 304 may include an interval of the next UWB event. For example, for a ranging round, the data 304 may include a ranging round interval. The data 304 may include hopping seed, STS Index0, etc. Further, in some embodiments the data 304 may include UWB transmission type (e.g., MMS or non-MMS). Further, the data 304 may include the UWB channel of the next UWB activity. In some embodiments, the data 304 may indicate a primary function of the UWB activity. For example, the data 304 may indicate whether the primary function (e.g., the purpose of the next UWB activity) is ranging or streaming.

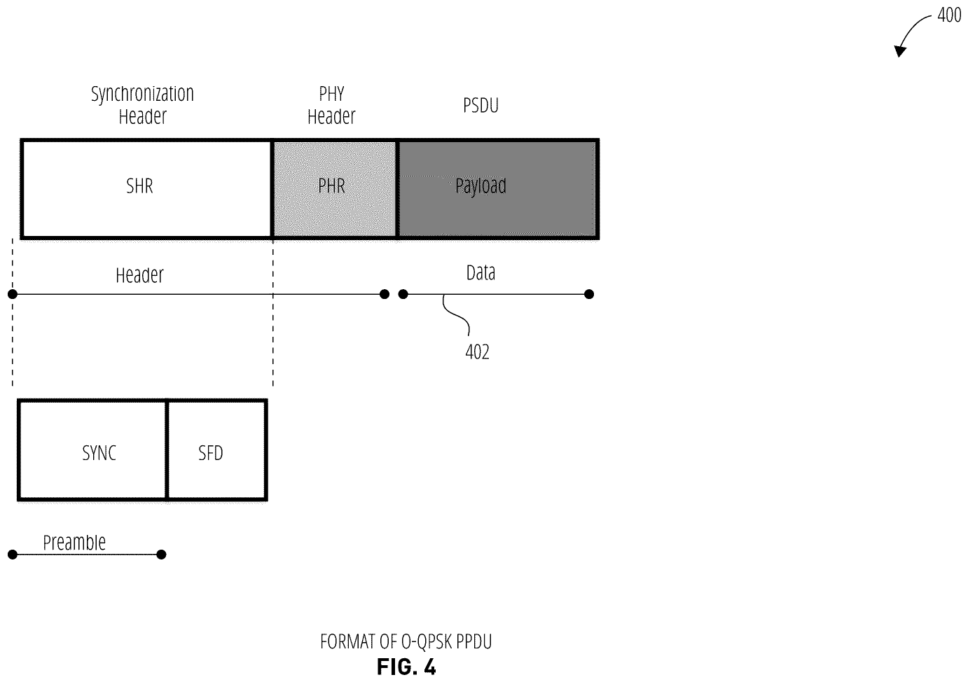

FIG. 4 illustrates the format of an NB-AP 400 (e.g., OOB-AP 212a from FIG. 2) in accordance with some embodiments. The NB-AP 400 may carry information that may be used by a device to predict future a UWB-AP occurrence. The Packet type of the NB-AP 400 may be an O-QPSK packet. For example, the NB-AP 400 may be a 250 Kbps modulated O-QPSK packet per legacy 15.4.

The NB-AP 400 may be transmitted on a NB discovery channel. The NB discovery channel may be used by initiators to periodically transmit their NB-AP 400. The NB discovery channel may be predefined. Further, in some embodiments there may be multiple pre-defined NB discovery channels.

The content of the NB-AP 400 (e.g., data 402) may be relatively small. NB transmissions can use more power and be more computational expensive than UWB transmissions. Therefore, it may be advantageous to keep the NB-AP 400 short. In some embodiments, the data 402 may include a relative offset from the NB-AP 400 to the next immediate UWB-AP (e.g., ΔT in FIG. 2). In some embodiments, the data 402 may include a UWB-AP preamble selection. In some embodiments, the data 402 may include a UWB-AP channel number. In some embodiments, the data 402 may include duplicate information found in the UWB-AP.

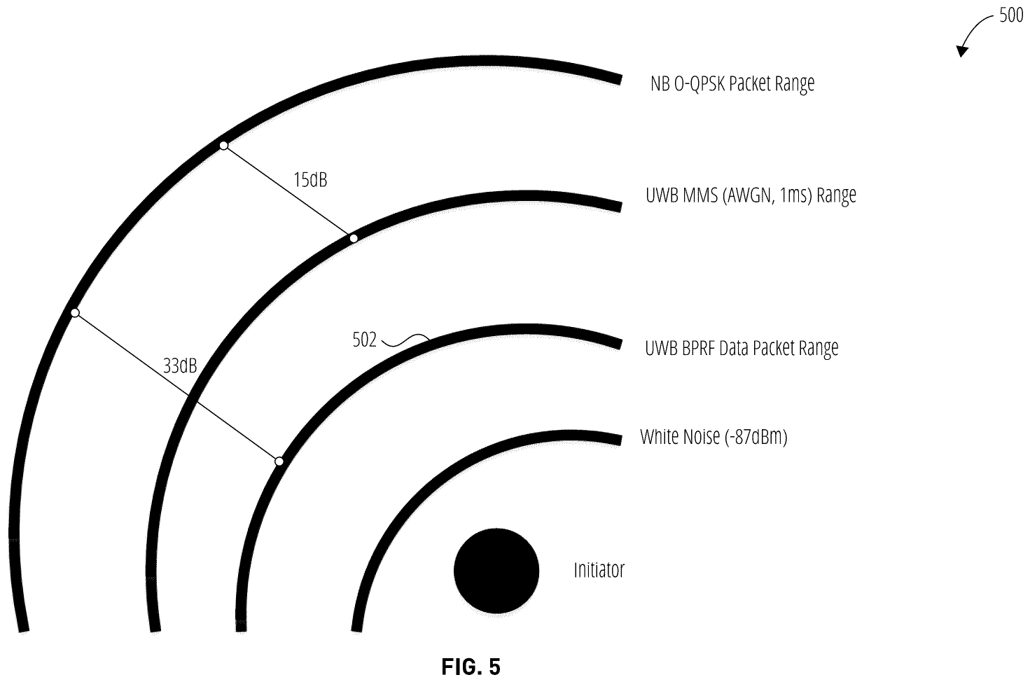

FIG. 5 illustrates ranges 500 for different packets. These ranges may be used to define a UWB coordination area size. Describes the size of the coordination area. So far describes the advertisement of UWB channels so neighboring cells can coordinate use of UWB channel to prevent interference. Some embodiments define a coordination area.

An initiator does both transmitting and receiving functions during an active ranging round. For example, a transmission sequence with respect to an initiator in a NB assisted UWB ranging may be as follows. The initiator may transmit a NB-Poll. The initiator may then receive NB-Response. The initiator may then transmit UWB multi-millisecond segments (MMS) transmission (Tx). The initiator may then receive UWB MMS reception (Rx). The initiator may then transmit NB-Feedback. The initiator may then receive NB-Feedback. Also, if an initiator is streaming the initiator may also do both transmitting and receiving functions (e.g., send data and receive acknowledgment).

Coordination between initiators may be used to avoid Interference-limited regime (interference much greater than noise (I»N)) operation on UWB channel. The UWB coordination area size should be set to avoid such interference-limited regime. As shown, white noise may be −87 dBm. Any interference more than white noise is a cause of concern for an initiator. The initiators with transmission less than white noise is not a cause of concern because they are below the noise level.

In some embodiments, initiators within UWB-AP range of each other coordinate between themselves about UWB channel usage to avoid Interference-limiting regime. In the illustrated embodiment, the UWB-AP is UWB BPRF Data Packet Range 502. The curve represents the coordination size. The difference between the UWB BPRF Data Packet Range 502 and the white noise may be a system implementations choice. Each system may have a different value for this difference.

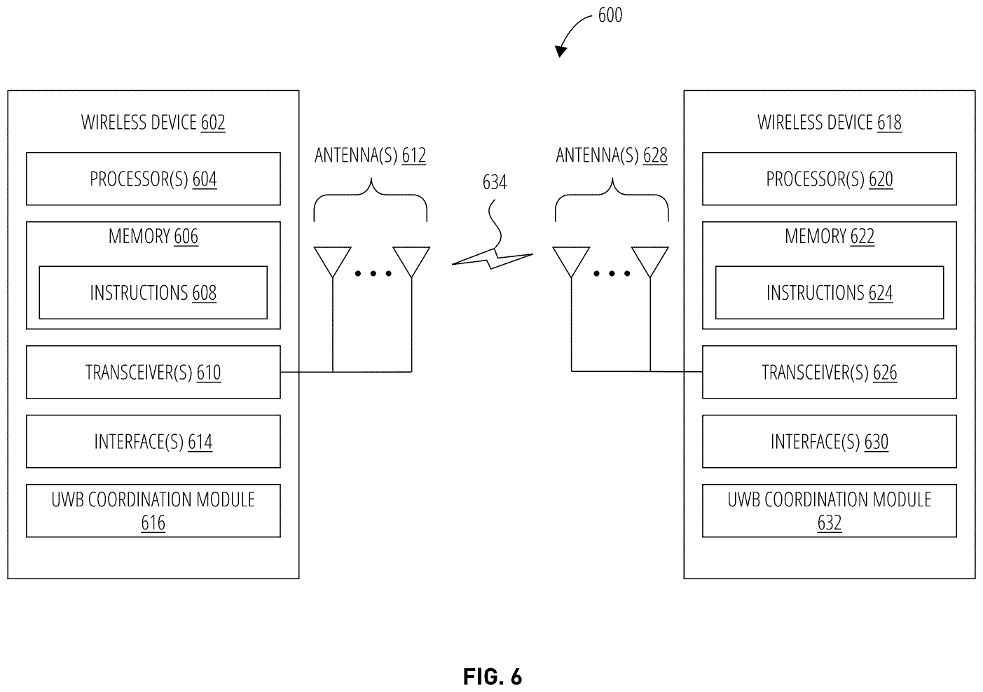

FIG. 6 illustrates a system 600 for performing signaling 634 between two wireless devices (i.e., first wireless device 602 and second wireless device 618) according to embodiments disclosed herein. The system 600 may be a portion of a wireless communications system as herein described. The wireless devices may be, for example, a user equipment (UE) of a wireless communication system, a beacon, a primary device, a controller, an initiator, a secondary devices, a controlee, or a responder.

The first wireless device 602 may include one or more processor(s) 604. The processor(s) 604 may execute instructions such that various operations of the first wireless device 602 are performed, as described herein. The processor(s) 604 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The first wireless device 602 may include a memory 606. The memory 606 may be a non-transitory computer-readable storage medium that stores instructions 608 (which may include, for example, the instructions being executed by the processor(s) 604). The instructions 608 may also be referred to as program code or a computer program. The memory 606 may also store data used by, and results computed by, the processor(s) 604.

The first wireless device 602 may include one or more transceiver(s) 610 that may include radio frequency (RF) transmitter and/or receiver circuitry that use the antenna(s) 612 of the first wireless device 602 to facilitate signaling (e.g., the signaling 634) to and/or from the first wireless device 602 with other devices (e.g., the second wireless device 618) according to corresponding RATs.

The first wireless device 602 may include one or more antenna(s) 612 (e.g., one, two, four, or more). For embodiments with multiple antenna(s) 612, the first wireless device 602 may leverage the spatial diversity of such multiple antenna(s) 612 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the first wireless device 602 may be accomplished according to precoding (or digital beamforming) that is applied at the first wireless device 602 that multiplexes the data streams across the antenna(s) 612 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the first wireless device 602 may implement analog beamforming techniques, whereby phases of the signals sent by the antenna(s) 612 are relatively adjusted such that the (joint) transmission of the antenna(s) 612 can be directed (this is sometimes referred to as beam steering).

The first wireless device 602 may include one or more interface(s) 614. The interface(s) 614 may be used to provide input to or output from the first wireless device 602. For example, a first wireless device 602 that is a UE may include interface(s) 614 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 610/antenna(s) 612 already described) that allow for communication between the UE and other devices and may operate according to known protocols (e.g., Wi-Fi®, Bluetooth®, and the like).

The first wireless device 602 may include a UWB coordination module 616. The UWB coordination module 616 may be implemented via hardware, software, or combinations thereof. For example, the UWB coordination module 616 may be implemented as a processor, circuit, and/or instructions 608 stored in the memory 606 and executed by the processor(s) 604. In some examples, the UWB coordination module 616 may be integrated within the processor(s) 604 and/or the transceiver(s) 610. For example, the UWB coordination module 616 may be implemented by a combination of software components (e.g., executed by a DSP or a general processor) and hardware components (e.g., logic gates and circuitry) within the processor(s) 604 or the transceiver(s) 610.

The UWB coordination module 616 may be used for various aspects of the present disclosure, for example, aspects of FIGS. 1-5. The UWB coordination module 616 is configured to encode or decode UWB-AP. In some embodiments, the UWB coordination module 616 is configured to encode or decode an OOB-AP (e.g., NB-AP).

A narrow band transmission as described in relation to FIGS. 1-6.

The second wireless device 618 may include one or more processor(s) 620. The processor(s) 620 may execute instructions such that various operations of the second wireless device 618 are performed, as described herein. The processor(s) 620 may include one or more baseband processors implemented using, for example, a CPU, a DSP, an ASIC, a controller, an FPGA device, another hardware device, a firmware device, or any combination thereof configured to perform the operations described herein.

The second wireless device 618 may include a memory 622. The memory 622 may be a non-transitory computer-readable storage medium that stores instructions 624 (which may include, for example, the instructions being executed by the processor(s) 620). The instructions 624 may also be referred to as program code or a computer program. The memory 622 may also store data used by, and results computed by, the processor(s) 620.

The second wireless device 618 may include one or more transceiver(s) 626 that may include RF transmitter and/or receiver circuitry that use the antenna(s) 628 of the second wireless device 618 to facilitate signaling (e.g., the signaling 634) to and/or from the second wireless device 618 with other devices (e.g., the first wireless device 602) according to corresponding RATs.

The second wireless device 618 may include one or more antenna(s) 628 (e.g., one, two, four, or more). In embodiments having multiple antenna(s) 628, the second wireless device 618 may perform MIMO, digital beamforming, analog beamforming, beam steering, etc., as has been described.

The second wireless device 618 may include one or more interface(s) 630. The interface(s) 630 may be used to provide input to or output from the second wireless device 618. For example, a second wireless device 618 that is a base station may include interface(s) 630 made up of transmitters, receivers, and other circuitry (e.g., other than the transceiver(s) 626/antenna(s) 628 already described) that enables the base station to communicate with other equipment in a core network, and/or that enables the base station to communicate with external networks, computers, databases, and the like for purposes of operations, administration, and maintenance of the base station or other equipment operably connected thereto.

The second wireless device 618 may include a UWB coordination module 632. The UWB coordination module 632 may be implemented via hardware, software, or combinations thereof. For example, the UWB coordination module 632 may be implemented as a processor, circuit, and/or instructions 624 stored in the memory 622 and executed by the processor(s) 620. In some examples, the UWB coordination module 632 may be integrated within the processor(s) 620 and/or the transceiver(s) 626. For example, the UWB coordination module 632 may be implemented by a combination of software components (e.g., executed by a DSP or a general processor) and hardware components (e.g., logic gates and circuitry) within the processor(s) 620 or the transceiver(s) 626.

The UWB coordination module 632 may be used for various aspects of the present disclosure, for example, aspects of FIGS. 1-6. The UWB coordination module 632 is configured to encode or decode UWB-AP. In some embodiments, the UWB coordination module 632 is configured to encode or decode an OOB-AP (e.g., NB-AP).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for an ultra-wideband (UWB) device, the method comprising:
encoding an UWB acquisition packet (UWB-AP) comprising information of future UWB channel usage of the UWB device;
periodically transmitting the UWB-AP;
encoding one or more UWB session transmissions; and
transmitting the one or more UWB session transmissions according to the information of future UWB channel usage of the UWB-AP.

2. The method of claim 1, further comprising:
encoding an out of band acquisition packet (OOB-AP) comprising information regarding a next transmission of the UWB-AP; and
periodically transmitting the OOB-AP.

3. The method of claim 2, wherein the OOB-AP is a narrow band acquisition packet (NB-AP).

4. The method of claim 3, wherein the NB-AP is an offset quadrature phase-shift keying (O-QPSK) packet.

5. The method of claim 2, wherein the OOB-AP comprises a relative offset to a next immediate UWB-AP.

6. The method of claim 1, wherein the UWB-AP is a base pulse repetition frequency (BPRF) data packet.

7. The method of claim 1, wherein the UWB-AP includes one or more of: a relative offset to a next ranging round, a ranging round length, a ranging round interval, a hopping seed, and a UWB transmission type.

8. The method of claim 1, wherein the UWB-AP is transmitted on a predefined UWB discovery channel.

9. The method of claim 1, further comprising:
monitoring for UWB-APs from neighboring UWB devices;
receiving and decoding the UWB-APs from the neighboring UWB devices;
determining UWB transmissions of the neighboring UWB devices based on the UWB-APs; and
adapting the UWB channel usage based on the UWB transmissions of the neighboring UWB devices.

10. The method of claim 9, wherein the neighboring UWB devices are those within UWB-AP range.

11. A method for an ultra-wideband (UWB) initiator, the method comprising:
receiving UWB acquisition packets (UWB-APs) comprising information of future UWB channel usage of neighboring UWB devices;
determining UWB transmissions of the neighboring UWB devices based on the UWB-APs; and
adapting UWB channel usage of the UWB initiator based on the UWB transmissions of the neighboring UWB devices.

12. The method of claim 11, further comprising:
encoding a personalized UWB-AP for the UWB initiator, the personalized UWB-AP comprising information of future UWB channel usage of the UWB initiator; and
periodically transmitting the personalized UWB-AP.

13. The method of claim 12, further comprising:
encoding an out of band acquisition packet (OOB-AP) comprising information regarding a next transmission of the personalized UWB-AP; and
periodically transmitting the OOB-AP.

14. The method of claim 13, wherein the OOB-AP is a narrow band acquisition packet (NB-AP).

15. The method of claim 14, wherein the NB-AP is an offset quadrature phase-shift keying (O-QPSK) packet.

16. The method of claim 13, wherein the OOB-AP comprises a relative offset to a next immediate transmission of the personalized UWB-AP.

17. The method of claim 11, wherein the UWB-APs are base pulse repetition frequency (BPRF) data packets.

18. The method of claim 11, wherein the UWB-APs include one or more of: a relative offset to a next ranging round, a ranging round length, a ranging round interval, a hopping seed, and a UWB transmission type.

19. The method of claim 11, wherein the UWB-APs are transmitted on a predefined UWB discovery channel.

20. The method of claim 11, wherein the neighboring UWB devices are those within UWB-AP range.
